(19) United States
(12) Patent Application Publication
(10) Pub. No.: US 2026/0340384 A1
(43) Pub. Date: Oct. 29, 2026

(54) LARGE LANGUAGE MODEL UPDATE METHOD, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Zhitao GAO, Beijing (CN); Xuhong LI, Beijing (CN); Zhenyu JIAO, Beijing (CN); Dai DAI, Beijing (CN)

(73) Assignee: BEIJING BAIDU NETCOM SCIENCE TECHNOLOGY CO., LTD., Beijing (CN)

(21) Appl. No.: 19/700,044

(22) Filed: Jun. 5, 2026

(30) Foreign Application Priority Data
Mar. 24, 2026 (CN) 202610369022.8

(51) Int. Cl. G06N 3/08

(52) U.S. Cl. CPC G06N 3/08

(57) ABSTRACT

A method of large language model update, an electronic device, and a storage medium are disclosed, which relates to the field of artificial intelligence technology, and in particular to the technical fields of large models, intelligent recommendation, deep learning, etc. The method of large language model update includes: performing autonomous data generation using an initial LLM to obtain synthetic data corresponding to multiple capabilities of the initial LLM; constructing preference samples based on the synthetic data corresponding to the multiple capabilities; training the initial LLM using the preference samples to obtain a target LLM.

The present application claims the priority of Chinese Patent Application No.202610369022.8, filed on Mar. 24, 2026, with the title of “Large Language Model Update Method, Apparatus, Device, Medium and Product”. The disclosure of the above application is incorporated herein by reference in its entirety.

### FIELD OF THE DISCLOSURE

The present application relates to the technical field of artificial intelligence, in particular to the technical fields of large models, deep learning, etc., and specifically to a method of large language model update, an electronic device, and a storage medium.

### BACKGROUND OF THE DISCLOSURE

With technological development, a large language model (LLM) can be used to perform a reasoning task. In order to obtain a better reasoning result, it is necessary to improve the reasoning capability of the LLM.

### SUMMARY OF THE DISCLOSURE

The present application provides a method of large language model update, an electronic device, and a storage medium.

According to an aspect of the present application, a method of large language model update is provided, including: performing autonomous data generation using an initial LLM to obtain synthetic data corresponding to multiple capabilities of the initial LLM; constructing preference samples based on the synthetic data corresponding to the multiple capabilities; training the initial LLM using the preference samples to obtain a target LLM.

According to another aspect of the present application, there is provided an electronic device, including: at least one processor; and a memory communicatively connected with the at least one processor; wherein the memory stores instructions executable by the at least one processor, and the instructions are executed by the at least one processor to enable the at least one processor to perform a method of large language model update, wherein the method of large language model includes: performing autonomous data generation using an initial LLM to obtain synthetic data corresponding to multiple capabilities of the initial LLM; constructing preference samples based on the synthetic data corresponding to the multiple capabilities; training the initial LLM using the preference samples to obtain a target LLM.

According to another aspect of the present application, there is provided a non-transitory computer readable storage medium with computer instructions stored thereon, wherein the computer instructions are used for causing a method of large language model update, wherein the method of large language model update includes: performing autonomous data generation using an initial large language model to obtain synthetic data corresponding to multiple capabilities of the initial large language model; constructing preference samples based on the synthetic data corresponding to the multiple capabilities; training the initial large language model using the preference samples to obtain a target large language model.

It should be understood that content described in this section is not intended to identify a key or important feature of an embodiment of the present application, nor is it intended to limit the scope of the present application. Another feature of the present application will become easily understood through the following description.

### BRIEF DESCRIPTION OF DRAWINGS

The accompanying drawings are used to better understand the present solution and do not constitute a limitation on the present application. In the drawings:

FIG. 1 is a schematic diagram according to a first embodiment of the present application;

FIG. 2 is a schematic diagram according to a second embodiment of the present application;

FIG. 3 is a schematic diagram of synthetic data corresponding to multiple capabilities provided according to an embodiment of the present application;

FIG. 4 is a schematic diagram according to a third embodiment of the present application;

FIG. 5 is a schematic diagram according to a fourth embodiment of the present application;

FIG. 6 is a schematic diagram of an electronic device for implementing a method of large language model update according to an embodiment of the present application.

### DETAILED DESCRIPTION OF PREFERRED EMBODIMENTS

A demonstrative embodiment of the present application is described below with reference to the accompanying drawings, which includes various details of the embodiment of the present application to facilitate understanding, and should be considered as merely demonstrative. Therefore, a person of ordinary skill in the art should recognize that various changes and modifications can be made to the embodiment described herein without departing from the scope and spirit of the present application. Similarly, for clarity and conciseness, a description of a well-known function and a well-known structure is omitted in the following description.

In a related technology, the reasoning capability of an LLM can be improved through reinforcement learning. However, the effect needs to be improved.

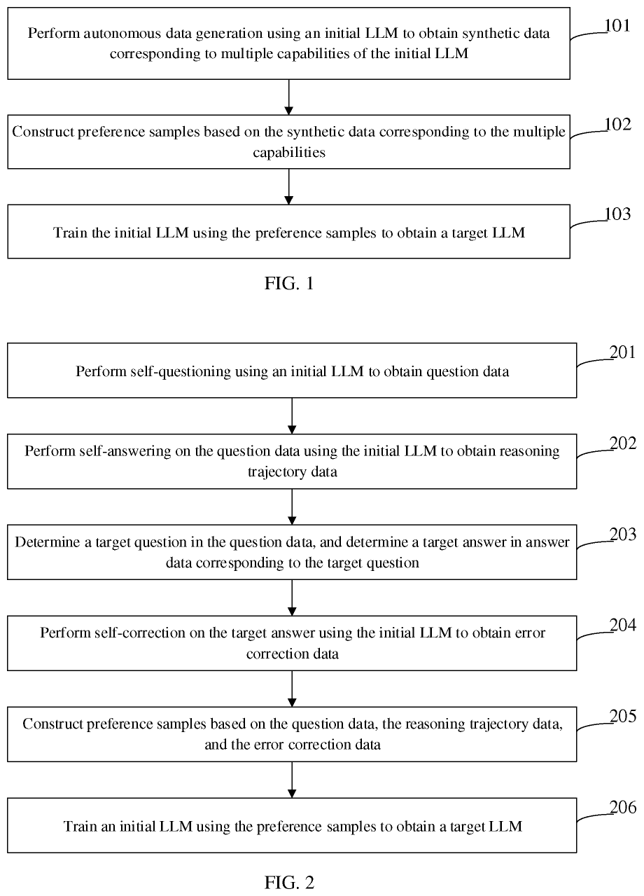

FIG. 1 is a schematic diagram according to a first embodiment of the present application. The present embodiment provides a method of large language model update. As shown in FIG. 1, the method includes:
101, performing autonomous data generation using an initial LLM to obtain synthetic data corresponding to multiple capabilities of the initial LLM.
102, constructing preference samples based on the synthetic data corresponding to the multiple capabilities.
103, training the initial LLM using the preference samples to obtain a target LLM.

In the present embodiment, the initial LLM refers to an LLM that requires improvement in reasoning ability. A reasoning field may specifically include: a mathematical reasoning field, a physical reasoning field, or a general question answering reasoning field, etc.

The autonomous data generation refers to using an initial LLM itself to perform data generation, without requiring manual annotation or an additionally introduced generation apparatus to perform generation.

Multiple capabilities specifically include: a self-questioning capability, a self-answering capability, and a self-correction capability. The synthetic data corresponding to the above-described capabilities can be respectively referred to as: question data, reasoning trajectory data, and error correction data.

After obtaining the synthetic data, preference samples can be constructed based on the synthetic data.

A preference sample is training data, which is configured to train an initial LLM to obtain a target LLM.

In the related technology, an evolution method based on reinforcement learning requires manual acquisition of training data. For example, an expert is required to annotate high-quality question data. In this case, the efficiency is poor and the data acquisition cost is high. In addition, a reward model needs to be additionally introduced, a reward signal is obtained by using the reward model, and a model is trained based on the reward signal. Since the reward model needs to be additionally introduced, the training cost is also high.

In the present embodiment, autonomous data generation is performed using an initial LLM to obtain synthetic data, preference samples are constructed based on the synthetic data, and the preference samples are used to train the initial LLM to obtain a target LLM. With the method of the present embodiment, data synthesis and training can be performed using the initial LLM itself, without requiring manual acquisition of training data. There is also no need to additionally introduce another model such as a reward model. In this way, the method of the present embodiment can achieve self-evolution of an LLM with high efficiency and high quality, which improves the reasoning capability of the LLM; In addition, by obtaining synthetic data corresponding to multiple capabilities and constructing preference samples based on the synthetic data corresponding to multiple capabilities, a richness of the samples can be improved, and a reasoning capability of the LLM can be further improved.

FIG. 2 is a schematic diagram according to a second embodiment of the present application. The present embodiment provides a method of large language model update.

In the embodiment, the multiple capabilities specifically include: a self-questioning capability, a self-answering capability, and a self-correction capability. The synthetic data corresponding to the above-described capabilities can be respectively referred to as: question data, reasoning trajectory data, and error correction data.

The overall method can be divided into an inner loop and an outer loop. In the inner loop, preference samples are obtained based on autonomous data generation of an initial LLM. In the outer loop, the preference samples are used to train the initial LLM to obtain a target LLM. The inner loop and the outer loop can be executed one or more times.

As shown in FIG. 2, the method includes:
201, performing self-questioning using an initial LLM to obtain question data.
202, performing self-answering on the question data using the initial LLM to obtain reasoning trajectory data.
203, determining a target question in the question data, and determining a target answer in answer data corresponding to the target question.
204, performing self-correction on the target answer using the initial LLM to obtain error correction data.
205, constructing preference samples based on the question data, the reasoning trajectory data, and the error correction data.
206, training an initial LLM using the preference samples to obtain a target LLM.

The above steps 201-205 belong to the inner loop process, and step 206 belongs to the outer loop process.

The inner loop and the outer loop can be executed for multiple rounds. In each iteration t, the inner loop obtains preference samples Dₜ through an initial LLM (model parameters are represented by

$${π}_{θ}^{t} ) ,$$

and the outer loop updates the model parameters

$${π}_{θ}^{t} )$$

of the initial LLM through the preference samples Dₜ to obtain a target LLM (model parameters are represented by

$${π}_{θ}^{t + 1} ) .$$

For an inner loop: a prompt can be used to instruct an initial LLM to play different roles, and the synthetic data corresponding to multiple capabilities is generated based on the different roles.

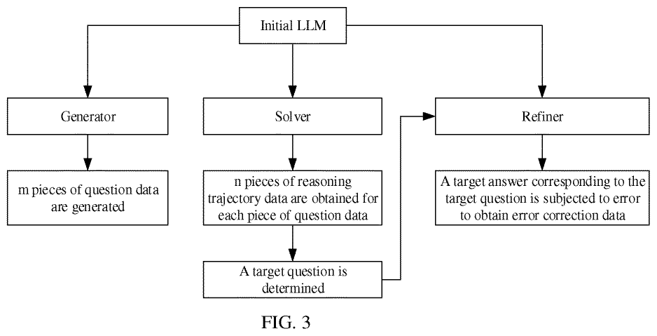

FIG. 3 is a schematic diagram of synthetic data corresponding to multiple capabilities provided according to an embodiment of the present application.

As shown in FIG. 3, an initial LLM can be instructed by a prompt to respectively act as a generator, a solver, and a refiner. When the initial LLM serves as the generator, m (a positive integer) pieces of question data are obtained through the generator; When the initial LLM serves as the solver, n (a positive integer) pieces of reasoning trajectory data are obtained for each piece of question data through the solver, including a step for solving the question data and final answer data; and a target question is determined in the m pieces of question data based on the answer data included in the n pieces of reasoning trajectory data; When the initial LLM serves as the refiner, a target answer corresponding to the target question is subjected to error correction through the refiner to obtain error correction data.

In the present embodiment, by obtaining the question data, the reasoning trajectory data, and the error correction data as the synthetic data, the self-questioning capability, the self-answering capability and the self-correction capability of the large language model can be comprehensively considered, and then after training is performed based on the synthetic data, the capabilities of the large language model can be synchronously improved.

Specifically, a first prompt can be input to an initial LLM, which includes role function information corresponding to a generator, such as “generating a challenging reasoning task”. The initial LLM can generate m pieces of question data based on the first prompt.

After the m pieces of question data are obtained, a second prompt can be input to an initial LLM, which includes role function information corresponding to a solver, such as “generating reasoning trajectory data for the following question data”. The initial LLM generates n pieces of reasoning trajectory data for each piece of question data based on the second prompt.

Afterwards, one or more target questions can be obtained from the m pieces of question data according to answer data included in the reasoning trajectory data.

In some embodiments, the reasoning trajectory data include: answer data corresponding to the question data;
the determining the target question in the question data includes:
clustering the answer data to obtain an answer cluster;
determining a target metric of the question data based on a probability of the answer cluster, the target metric being configured to measure an execution difficulty of the question data;
determining the target question in the question data based on the target metric.

In these embodiments, after n pieces of reasoning trajectory data are obtained for each piece of question data, answer data included in each piece of reasoning trajectory data can be obtained, and n pieces of answer data are obtained in total. Afterwards, based on an equivalence of the answer data (such as a similarity between pairwise answer data), the n pieces of answer data are clustered into k (a positive integer) answer clusters, and each answer cluster is a set of answer data, including one or more pieces of answer data.

After k answer clusters are obtained for respective pieces of question data, a target metric can be calculated according to the probabilities of respective answer clusters, and the target metric is configured to measure an execution difficulty of the question data.

The process is represented by a formula as:
a generator

$${π}_{g}^{t}$$

generates m pieces of question data

$${Q}^{t} = \{ {q}_{1}^{t} , … , {q}_{m}^{t} \} ,$$

wherein

$${q}_{i}^{t} ( 1 \leq i \leq m )$$

is an i-th piece of question data in a t-th iteration;
for each piece of question data

$${q}_{i}^{t} ,$$

a solver

$${π}_{s}^{t}$$

generates n pieces of independent reasoning trajectory data

$${T}_{i}^{t} = \{ {y}_{i , 1}^{t} , … , {y}_{i , n}^{t} \} ,$$

wherein

$${y}_{i , j}^{t} ( 1 \leq j \leq n )$$

is a j-th piece of reasoning trajectory data corresponding to the question data

$${q}_{i}^{t} ;$$

for each piece of question data

$${q}_{i}^{t} ,$$

the answer data included in the n pieces of reasoning trajectory data are clustered to obtain an answer cluster

$${C}_{i}^{t} = \{ {c}_{i , l}^{1} , … , {c}_{i , k}^{t} \} ,$$

wherein

$${c}_{i , j}^{t} ( 1 \leq j \leq k )$$

is a j-th piece of answer cluster corresponding to the question data

$${q}_{i}^{t} ;$$

a target metric calculated based on an answer cluster can specifically be a normalized Shannon entropy, and a calculation formula is:

$$\overline{H} ( {q}_{i}^{t} ) = - \frac{1}{{log}_{2} n} {\sum }_{j = 1}^{k} P ( {c}_{i , j}^{t} ) {log}_{2} P ( {c}_{i , j}^{t} )$$

wherein,

$$\overline{H} ( {q}_{i , j}^{t} )$$

is a normalized Shannon entropy of question data

$${q}_{i}^{t} ;$$

$$P ( {c}_{i , j}^{r} )$$

is a probability of

$${c}_{i , j}^{t} ,$$

which can be calculated according to the number of the answers included in an answer cluster. For example, the answer cluster includes a first answer cluster and a second answer cluster, if the number of answer data in the first answer cluster is n1, and the number of answer data in the second answer cluster is n2, then a probability of the first answer cluster=n1/(n1+n2), and a probability of the second answer cluster=n2/(n1+n2).

After the target metric is obtained, question data with the target metric located within a preset first threshold and a preset second threshold can be taken as a target question.

That is, three regions can be defined based on the target metric:
a mastered region

$$\overline{H} ( {q}_{i}^{t} ) < {τ}_{low} ,$$

indicating that a task is too simple;
a proximal development region

$${τ}_{low} \leq \overline{H} ( {q}_{i}^{t} ) < {τ}_{high} ,$$

which is an optimal learning region;
a chaotic region

$$\overline{H} ( {q}_{i}^{t} ) > {τ}_{high} ,$$

indicating that a task is too complex;
wherein, τ_{low}, τ_{high} are the preset first threshold and the preset second threshold.

Based on the regions, question data located in the proximal development region is taken as a target question.

In the present embodiment, the execution difficulty of the question data can be accurately identified based on a target metric, thereby a target question is accurately determined, and a feasibility is improved.

In some embodiments, the determining the target answer in the answer data corresponding to the target question includes:
determining a target trajectory data in the reasoning trajectory data corresponding to the target question based on a probability of an answer cluster corresponding to the target question.

In the present embodiment, a preset number of answer clusters can be selected in a descending order of the probability of the answer cluster, and answer data in the selected answer cluster is taken as the target answer.

Assuming the preset number=2, then answer data within the answer cluster

$${c}_{i , j}^{t} \qquad ( j = 1 , 2 )$$

with the higher probability is taken as the target answer.

In the embodiment, by determining a target answer based on the probability of an answer cluster, it can efficiently obtain the target answer and improve the processing efficiency.

After the target question and the target answer are determined, a refiner

$${π}_{r}^{t}$$

is adopted to obtain error correction data.

In some embodiments, there are a plurality of target answers;
the performing self-correction on the target answer to obtain error correction data includes:
performing correction on the plurality of target answers based on a counterfactual correction algorithm to obtain multiple sets of correction trajectory data;
in response to answer data corresponding to the multiple sets of correction trajectory data being consistent, taking the multiple sets of correction trajectory data as the error correction data.

In the present embodiment, a refiner verifies the correctness of the reasoning based on an independent counterfactual correction mechanism through logical convergence rather than statistical consensus. Specifically, the verification may include:
for each target question (that is, question data located in a proximal development region)

$${q}_{r}^{t} ,$$

two answer clusters

$${c}_{t , 1}^{t} , {c}_{t , 2}^{t}$$

with the highest probabilities are obtained;
the refiner

$${π}_{r}^{t}$$

re-solves a task under a counterfactual hypothesis: assuming that the previously proposed answer data is wrong, the model is forced to re-think and construct independent reasoning trajectory data, by which correction trajectory data

$${\tilde{y}}_{i , j}^{t} \qquad ( j = 1 , 2 )$$

corresponding to the two answer clusters is obtained;
if answer data included in the multiple sets of correction trajectory data is consistent, that is,

$${\tilde{y}}_{i , j}^{t} \qquad ( j = 1 , 2 )$$

corresponds to the same answer data, the multiple sets of correction trajectory data are taken as error correction data, and the consistent answer data can be referred to as a ground-truth answer.

In the present embodiment, in response to answer data corresponding to the multiple sets of correction trajectory data being consistent, the multiple sets of correction trajectory data are taken as error correction data. The error correction data can be obtained based on internal logical consistency rather than statistical consistency, and then preference samples are obtained, so that the reliability of training data is improved, and the performance of the large model is improved.

After obtaining the question data, the reasoning trajectory data and the error correction data, preference samples can be constructed based on the three data.

That is, a first sample

$${D}_{g}^{t}$$

can be constructed based on the question data, a second sample

$${D}_{s}^{t}$$

can be constructed based on the reasoning trajectory data, and a third sample

$${D}_{r}^{t}$$

can be constructed based on the error correction data. Afterwards, the preference samples D^{t} are formed by the first sample

$${D}_{g}^{t} ,$$

the second sample

$${D}_{s}^{t}$$

and the third sample

$${D}_{r}^{t} .$$

That is, the preference samples are a set of the first sample, the second sample and the third sample.

In the present embodiment, preference samples are obtained based on the first sample, the second sample and the third sample, which can improve the richness of the preference samples, thereby improving the reasoning capability of an LLM.

Since the synthetic data include the above three types, for different types, a corresponding positive sample can be determined in the following manner:
for the question data: a target question (question data located in a proximal development region) is taken as a positive sample, otherwise as a negative sample;
for the reasoning trajectory data: the reasoning trajectory data with the answer data being the ground-truth answer is taken as a positive sample, otherwise as a negative sample;
for the error correction data: only a positive sample is reserved, and the positive sample is the correction trajectory data corresponding to an error answer corrected to a ground-truth answer.

For example, a target answer includes: a first answer and a second answer. First correction trajectory data are obtained based on the first answer (e.g., 0) through a refiner, and second correction trajectory data are obtained based on the second answer (e.g., ½). Assuming that answer data corresponding to the first correction trajectory data and the second correction trajectory data are the same (e.g., both are 0), a ground-truth answer is 0, a positive sample in the error correction data is the second correction trajectory data, and a positive sample in the reasoning trajectory data is reasoning trajectory data corresponding to the answer 0.

A preference sample includes synthetic data and a preference label, and the preference label is configured to represent a preference degree of the synthetic data. For example, the preference label is represented by 1 or 0, where 1 represents that corresponding synthetic data is a positive sample, and 0 represents that corresponding synthetic data is a negative sample.

Taking the question data as an example, if the first question data is a positive sample, a preference label corresponding to the first question data is 1. A first sample

$${D}_{g}^{t}$$

can be obtained based on the first question data and the corresponding preference label. The second sample and the third sample can also be obtained in a similar manner.

In this way, a preference label is generated based on a predefined rule, and a preference label corresponding to the synthetic data can be automatically determined without manual annotation or determination based on an additional model such as a reward model. Therefore, the calculation overhead can be reduced and the processing efficiency can be improved.

Further, in combination with the subsequent description, the training process can adopt a KTO (Kahneman-Tversky optimization) training method. Under the training method, a sample is a triple, that is, each set of samples includes (a prompt sample, a response sample, a preference label). The prompt sample is an input of an LLM, the response sample is an output of the LLM, and the preference label corresponds to the response sample.

That is, the preference sample can include: a prompt sample, a response sample and a preference label. The preference label is generated based on a predefined rule and is configured to represent whether the response sample is a positive sample or a negative sample. For example, 1 is used to represent a positive sample, and 0 is used to represent a negative sample.

A prompt sample is input to an initial LLM to obtain an output probability of a response sample, a loss function is constructed based on the output probability and a preference label corresponding to the response sample, and model parameters of the initial LLM are adjusted based on the loss function to obtain a target LLM.

Specifically, for a first sample

$${D}_{g}^{t} :$$

a prompt sample refers to prompt indicating that an LLM acts as a generator, a response sample is question data generated by the LLM, and a preference label is a 1 or 0 label determined based on a positive sample and a negative sample in the question data;

For a second sample

$${D}_{s}^{t} :$$

a prompt sample refers to prompt indicating that an LLM acts as a solver, a response sample is reasoning trajectory data for question data generated by the LLM, and a preference label is a 1 or 0 label determined based on a positive sample and a negative sample in the reasoning trajectory data;

For a third sample

$${D}_{r}^{t} :$$

a prompt sample refers to prompt indicating that an LLM acts as a refiner, a response sample is error correction data generated by the LLM for a target answer of a target question, which only includes a positive sample in the error correction data, and a preference label is represented by 1.

After obtaining the preference samples, an initial LLM is trained to obtain a target LLM.

That is, the prompt sample can be input to the initial LLM to obtain an output probability of a response sample, a loss function can be constructed based on the output probability and a preference label, and the model parameters of the initial LLM are adjusted based on the loss function to obtain a target LLM.

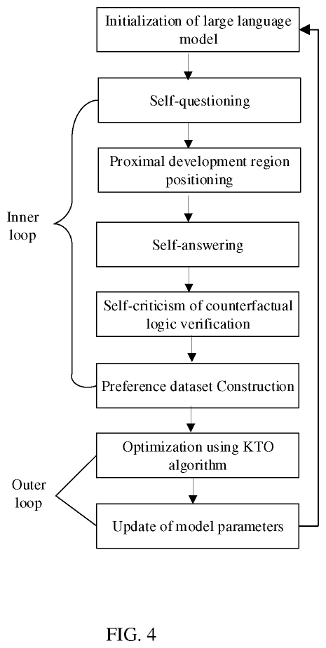

In combination with the above description, referring to FIG. 4, an evolution (update) process of a large language model mainly includes one or more iteration rounds. Each iteration round includes an inner loop and an outer loop. The inner loop mainly includes self-questioning, proximal development region positioning, self-answering and self-criticism (self-correction) of counterfactual logic verification. Through the process, three types of synthetic data can be obtained, and then a preference dataset is constructed based on the synthetic data. The outer loop can be optimized by using a KTO algorithm to achieve update of model parameters. By repeating the process continuously, continuous evolution of the large language model can be achieved.

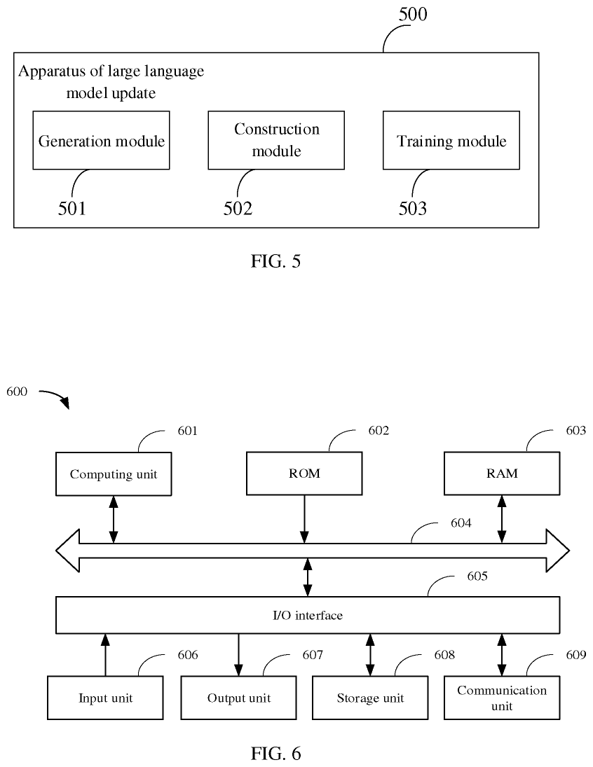

FIG. 5 is a schematic diagram according to a third embodiment of the present application. The present embodiment provides an apparatus of large language model update. As shown in FIG. 5, the apparatus 500 includes: a generation module 501, a construction module 502 and a training module 503.

The generation module 501 is configured to perform autonomous data generation using an initial LLM to obtain synthetic data corresponding to multiple capabilities of the initial LLM; the construction module 502 is configured to construct preference samples based on the synthetic data corresponding to the multiple capabilities; the training module 503 is configured to train the initial LLM using the preference samples to obtain a target LLM.

In the present embodiment, autonomous data generation is performed using an initial LLM to obtain synthetic data, preference samples are constructed based on the synthetic data, and the preference samples are used to train the initial LLM to obtain a target LLM. With the method of the present embodiment, data synthesis and training can be performed using the initial LLM itself, without requiring manual acquisition of training data. There is also no need to additionally introduce another model such as a reward model. In this way, the method of the present embodiment can achieve self-evolution of an LLM with high efficiency and high quality, which improves the reasoning capability of the LLM; In addition, by obtaining synthetic data corresponding to multiple capabilities and constructing preference samples based on the synthetic data corresponding to multiple capabilities, a richness of the samples can be improved, and a reasoning capability of the LLM can be further improved.

In some embodiments, the synthetic data corresponding to the multiple capabilities include: question data, reasoning trajectory data, and error correction data;
the generation module 501 is further configured to:
perform self-questioning using an initial LLM to obtain question data;
perform self-answering on the question data using the initial LLM to obtain reasoning trajectory data;
determine a target question in the question data, and determine a target answer in answer data corresponding to the target question;
perform self-correction on the target answer using the initial LLM to obtain error correction data.

In the present embodiment, by obtaining the question data, the reasoning trajectory data, and the error correction data as the synthetic data, the self-questioning capability, the self-answering capability and the self-correction capability of the large language model can be comprehensively considered, and then after training is performed based on the synthetic data, the capabilities of the large language model can be synchronously improved.

In some embodiments, the reasoning trajectory data include: answer data corresponding to the question data;
the generation module 501 is further configured to:
cluster the answer data to obtain an answer cluster;
determine a target metric of the question data based on a probability of the answer cluster, the target metric being configured to measure an execution difficulty of the question data;
determine the target question in the question data based on the target metric.

In the present embodiment, the execution difficulty of the question data can be accurately identified based on a target metric, thereby a target question is accurately determined, and a feasibility is improved.

In some embodiments, the generation module 501 is further configured to:
cluster the answer data based on a similarity between pairwise answer data to obtain an answer cluster, each answer cluster including at least one answer data.

In this way, answer data with a relatively higher similarity can be clustered into the same answer cluster, thereby obtaining the answer cluster efficiently and simply.

In some embodiments, the target metric is a normalized Shannon entropy determined based on the probability, the probability being determined based on the quantity of answer data included in the answer cluster;
the generation module 501 is further configured to:
determine question data with the target metric located within a preset first threshold and a preset second threshold as a target question.

In this way, question data in an optimal learning region can be taken as a target question. Training an initial LLM using the target question is beneficial for improving the learning capability of the initial LLM, thereby obtaining a better-performing target LLM.

In some embodiments, the generation module 501 is further configured to:
determine the target answer in the answer data corresponding to the target question based on a probability of an answer cluster corresponding to the target question.

In the embodiment, by determining a target answer based on a probability of an answer cluster, it can efficiently obtain the target answer and improve the processing efficiency.

In some embodiments, the generation module 501 is further configured to:
select a preset number of answer clusters in a descending order of a probability of the answer cluster, and take answer data within a selected answer cluster as the target answer.

In this way, answer data with a higher probability can be taken as a target answer, thereby improving the effectiveness of the target answer. Furthermore, after performing error correction on the target answer, the effect of error correction can be improved, thereby enhancing the reasoning accuracy of an updated LLM.

In some embodiments, there are a plurality of target answers;
the generation module 501 is further configured to:
perform correction on the plurality of target answers based on a counterfactual correction algorithm to obtain multiple sets of correction trajectory data;
in response to answer data corresponding to the multiple sets of correction trajectory data being consistent, take the multiple sets of correction trajectory data as the error correction data.

In the present embodiment, in response to answer data corresponding to the multiple sets of correction trajectory data being consistent, the multiple sets of correction trajectory data are taken as error correction data. The error correction data can be obtained based on internal logical consistency rather than statistical consistency, and then preference samples are obtained, so that the reliability of training data is improved, and the performance of the large model is improved.

In some embodiments, the synthetic data corresponding to the multiple capabilities include: question data, reasoning trajectory data, and error correction data.

The construction module 502 is further configured to:
construct a first sample based on the question data;
construct a second sample based on the reasoning trajectory data;
construct a third sample based on the error correction data;
form the preference samples by the first sample, the second sample and the third sample.

In the embodiment, by obtaining preference samples based on the first sample, the second sample and the third sample, the richness of the preference samples can be improved, thereby improving the reasoning capability of an LLM.

In some embodiments, the construction module 502 is further configured to:
take a target question in the question data as a positive sample in the first sample, and take other question data as a negative sample in the first sample; and/or,
take reasoning trajectory data corresponding to a ground-truth answer in the answer data as a positive sample in the second sample, and take other answer data as a negative sample in the second sample; and/or,
retain a positive sample in the error correction data as the third sample, the positive sample being correction trajectory data corresponding to an error answer corrected to a ground-truth answer.

In this way, a positive sample and a negative sample can be determined according to the above-described rules, without a need for manual annotation of the positive sample and the negative sample, thereby reducing the cost and obtaining the positive sample and the negative sample accurately and efficiently.

In some embodiments, the preference samples include: a prompt sample, a response sample, and a preference label. The preference label is generated based on a predefined rule and configured to represent whether the response sample is a positive sample or a negative sample;
the training module 503 is further configured to:
input the prompt sample into an initial large language model to obtain an output probability of the response sample;
construct a loss function based on the output probability and the preference label;
adjust model parameters of the initial large language model based on the loss function to obtain the target large language model.

In this way, the model training is performed based on the prompt sample, the response sample, and the preference label, and the preference label is determined based on a predefined rule, eliminating a need to introduce an additional reward model or the like to determine a reference signal, thereby saving the resource and improving the training efficiency.

It can be understood that, in an embodiment of the present application, same or similar content in different embodiments may be referred to each other.

It can be understood that, “first”, “second”, etc. in the embodiments of the present application are only used for distinction, and do not represent a degree of importance, a temporal sequence, etc.

It can be understood that if an order of steps involved in a process is not specifically limited, it means that a temporal relationship between these steps is not limited.

In a technical solution of the present application, collection, storage, use, processing, transmission, provision, disclosure and other processing of various types of information such as user personal information comply with provisions of relevant laws and regulations and do not violate public order and good customs.

According to an embodiment of the present application, the present application further provides an electronic device, a readable storage medium, and a computer program product.

FIG. 6 shows a schematic block diagram of an example electronic device 600 that can be used to implement an embodiment of the present application. The electronic device 600 is intended to represent various forms of digital computers, such as a laptop computer, a desktop computer, a workstation, a server, a blade server, a mainframe computer, and another suitable computer. The electronic device may also represent various forms of mobile devices, such as a personal digital assistant, a cellular phone, a smart phone, a wearable device, and another similar computing device. A component shown herein, a connection and a relationship thereof, and a function thereof are merely examples and are not intended to limit an implementation of the present application described and/or claimed herein.

As shown in FIG. 6, the electronic device 600 includes a computing unit 601, which can perform various appropriate actions and processes according to a computer program stored in a read-only memory (ROM) 602 or a computer program loaded from a storage unit 606 into a random access memory (RAM) 603. In the RAM 603, various programs and data required for an operation of the electronic device 600 can also be stored. The computing unit 601, the ROM 602, and the RAM 603 are connected to each other via a bus 604. An input/output (I/O) interface 605 is also connected to the bus 604.

Multiple components in the electronic device 600 are connected to the I/O interface 605, including: an input unit 606, such as a keyboard, a mouse, etc.; an output unit 607, such as various types of displays, speakers, etc.; a storage unit 608, such as a magnetic disk, an optical disk, etc.; and a communication unit 609, such as a network card, a modem, a wireless communication transceiver, etc. The communication unit 609 allows the electronic device 600 to exchange information/data with another device via a computer network such as the Internet and/or various telecommunication networks.

The computing unit 601 may be various general-purpose and/or special-purpose processing components having a processing and computing capability. Some examples of the computing unit 601 include, but are not limited to, a central processing unit (CPU), a graphics processing unit (GPU), various dedicated artificial intelligence (AI) computing chips, various computing units running a machine learning model algorithm, a digital signal processor (DSP), and any appropriate processor, controller, microcontroller, etc. The computing unit 601 performs the various methods and processes described above, such as the method of large language model update. For example, in some embodiments, the method of large language model update may be implemented as a computer software program tangibly embodied on a machine-readable medium, such as the storage unit 608. In some embodiments, part or all of the computer program may be loaded and/or installed onto the electronic device 600 via the ROM 602 and/or the communication unit 609. When the computer program is loaded into the RAM 603 and executed by the computing unit 601, one or more steps of the method of large language model update described above can be performed. Alternatively, in other embodiments, the computing unit 601 may be configured to perform the method of large language model update by any other appropriate means (e.g., by means of firmware).

Various implementations of a system and a technology described herein above may be implemented in a digital electronic circuit system, an integrated circuit system, a field programmable gate array (FPGA), an application specific integrated circuit (ASIC), an application specific standard product (ASSP), a system on a chip (SOC), a complex programmable logic device (CPLD), computer hardware, firmware, software, and/or a combination thereof. These various implementations may include being implemented in one or more computer programs that are executable and/or interpretable on a programmable system including at least one programmable processor, which may be a special-purpose or general-purpose programmable processor, that receives data and instructions from a storage system, at least one input device, and at least one output device, and transmits data and instructions to the storage system, the at least one input device, and the at least one output device.

A program code for implementing a method of the present application may be written in any combination of one or more programming languages. The program code may be provided to a processor or a controller of a general-purpose computer, a special-purpose computer, or another programmable task processing device, such that the program code, when executed by the processor or the controller, causes a function/operation specified in a flowchart and/or a block diagram to be performed. The program code may be executed entirely on a machine, partly on a machine, as a stand-alone software package partly on a machine and partly on a remote machine, or entirely on a remote machine or a server.

In the context of the present application, a machine-readable medium may be a tangible medium that may contain or store a program for use by or in connection with an instruction execution system, an apparatus, or a device. A machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. A more specific example of a machine-readable storage medium includes an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

To provide an interaction with a user, the system and the technology described herein may be implemented on a computer having: a display device for displaying information to the user (e.g., a CRT (cathode ray tube) or LCD (liquid crystal display) monitor); and a keyboard and a pointing device (e.g., a mouse or a trackball) through which the user can provide an input to the computer. Another kind of device may also be used to provide an interaction with a user; for example, a feedback provided to the user may be any form of sensory feedback (e.g., visual feedback, auditory feedback, or tactile feedback); and an input from the user may be received in any form (including an acoustic input, a voice input, or a tactile input).

The system and the technology described herein may be implemented in a computing system that includes a back-end component (e.g., as a data server), or a computing system that includes a middleware component (e.g., an application server), or a computing system that includes a front-end component (e.g., a user computer having a graphical user interface or a web browser through which a user can interact with an implementation of the system and the technology described herein), or a computing system that includes any combination of such a back-end component, a middleware component, or a front-end component. A component of the system may be interconnected by any form or medium of digital data communication (e.g., a communication network). An example of a communication network includes a local area network (LAN), a wide area network (WAN), and the Internet.

A computer system may include a client and a server. The client and the server are generally remote from each other and typically interact through a communication network. A client-server relationship is generated by a computer program running on a respective computer and having a client-server relationship with each other. The server may be a cloud server, also known as a cloud computing server or a cloud host, which is a host product in a cloud computing service system, solving a defect of a great management difficulty and a weak business scalability existing in a traditional physical host and a VPS service (“Virtual Private Server”, or “VPS”). The server may also be a server of a distributed system, or a server combined with a blockchain.

It should be understood that various forms of flows shown above may be used, with steps reordered, added, or deleted. For example, the steps described in the present application may be performed in parallel, sequentially, or in a different order, as long as the desired result of a technical solution disclosed in the present application can be achieved, which is not limited herein.

The above specific embodiments do not constitute a limitation on the protection scope of the present application. A person skilled in the art should understand that various modifications, combinations, sub-combinations, and substitutions may be made according to the design requirement and other factors. Any modification, equivalent replacement, and improvement made within the spirit and principle of the present application shall be included in the protection scope of the present application.

What is claimed is:

1. A method of large language model update, comprising:
performing autonomous data generation using an initial large language model to obtain synthetic data corresponding to multiple capabilities of the initial large language model;
constructing preference samples based on the synthetic data corresponding to the multiple capabilities;
training the initial large language model using the preference samples to obtain a target large language model.

2. The method according to claim 1, wherein,
the synthetic data corresponding to the multiple capabilities comprise: question data, reasoning trajectory data, and error correction data;
the performing autonomous data generation using the initial large language model to obtain synthetic data corresponding to multiple capabilities of the initial large language model comprises:
performing self-questioning using the initial large language model to obtain the question data;
performing self-answering on the question data using the initial large language model to obtain the reasoning trajectory data;
determining a target question in the question data, and determining a target answer in answer data corresponding to the target question;
performing self-correction on the target answer using the initial large language model to obtain the error correction data.

3. The method according to claim 2, wherein,
the reasoning trajectory data comprise: answer data corresponding to the question data;
the determining the target question in the question data comprises:
clustering the answer data to obtain an answer cluster;
determining a target metric of the question data based on a probability of the answer cluster, the target metric being configured to measure an execution difficulty of the question data;
determining the target question in the question data based on the target metric.

4. The method according to claim 3, wherein the clustering the answer data to obtain the answer cluster comprises:
clustering the answer data based on a similarity between pairwise answer data to obtain an answer cluster, each answer cluster comprising at least one answer data.

5. The method according to claim 4, wherein,
the target metric is a normalized Shannon entropy determined based on the probability, the probability being determined based on a quantity of answer data included in the answer cluster;
the determining the target question in the question data based on the target metric comprises:
determining question data having the target metric within a preset first threshold and a preset second threshold as the target question.

6. The method according to claim 3, wherein the determining the target answer in the answer data corresponding to the target question comprises:
determining the target answer in the answer data corresponding to the target question based on the probability of the answer cluster corresponding to the target question.

7. The method according to claim 6, wherein the determining the target answer in the answer data corresponding to the target question based on the probability of the answer cluster corresponding to the target question comprises:
selecting a preset number of answer clusters in a descending order of the probability of the answer cluster, and taking answer data within a selected answer cluster as the target answer.

8. The method according to claim 2, wherein,
there are a plurality of target answers;
the performing self-correction on the target answer to obtain the error correction data comprises:
performing correction on the plurality of target answers based on a counterfactual correction algorithm to obtain multiple sets of correction trajectory data;
in response to answer data corresponding to the multiple sets of correction trajectory data being consistent, taking the multiple sets of correction trajectory data as the error correction data.

9. The method according to claim 1, wherein,
the synthetic data corresponding to the multiple capabilities comprise: question data, reasoning trajectory data, and error correction data;
the constructing preference samples based on the synthetic data corresponding to the multiple capabilities comprises:
constructing a first sample based on the question data;
constructing a second sample based on the reasoning trajectory data;
constructing a third sample based on the error correction data;
forming the preference samples by the first sample, the second sample, and the third sample.

10. The method according to claim 9, wherein,
the constructing the first sample based on the question data comprises: taking the target question in the question data as a positive sample in the first sample, and taking other question data as a negative sample in the first sample; and/or,
the constructing the second sample based on the reasoning trajectory data comprises: taking reasoning trajectory data corresponding to a ground-truth answer in the answer data as a positive sample in the second sample, and taking other answer data as a negative sample in the second sample; and/or,
the constructing the third sample based on the error correction data comprises: retaining a positive sample in the error correction data as the third sample, the positive sample being correction trajectory data corresponding to a correction from an error answer to a ground-truth answer.

11. The method according to claim 1, wherein,
the preference samples comprise: a prompt sample, a response sample, and a preference label, the preference label being generated based on a predefined rule and configured to represent whether the response sample is a positive sample or a negative sample;
the training the initial large language model using the preference samples to obtain the target large language model comprises:
inputting the prompt sample into an initial large language model to obtain an output probability of the response sample;
constructing a loss function based on the output probability and the preference label;
adjusting model parameters of the initial large language model based on the loss function to obtain the target large language model.

12. An electronic device, comprising:
at least one processor; and
a memory communicatively connected with the at least one processor;
wherein the memory stores instructions executable by the at least one processor, and the instructions are executed by the at least one processor to enable the at least one processor to perform a method of large language model update, wherein the method of large language model update comprises:
performing autonomous data generation using an initial large language model to obtain synthetic data corresponding to multiple capabilities of the initial large language model;
constructing preference samples based on the synthetic data corresponding to the multiple capabilities;
training the initial large language model using the preference samples to obtain a target large language model.

13. The electronic device according to claim 12, wherein,
the synthetic data corresponding to the multiple capabilities comprise: question data, reasoning trajectory data, and error correction data;
the performing autonomous data generation using the initial large language model to obtain synthetic data corresponding to multiple capabilities of the initial large language model comprises:
performing self-questioning using the initial large language model to obtain the question data;
performing self-answering on the question data using the initial large language model to obtain the reasoning trajectory data;
determining a target question in the question data, and determining a target answer in answer data corresponding to the target question;
performing self-correction on the target answer using the initial large language model to obtain the error correction data.

14. The electronic device according to claim 13, wherein,
the reasoning trajectory data comprise: answer data corresponding to the question data;
the determining the target question in the question data comprises:
clustering the answer data to obtain an answer cluster;
determining a target metric of the question data based on a probability of the answer cluster, the target metric being configured to measure an execution difficulty of the question data;
determining the target question in the question data based on the target metric.

15. The electronic device according to claim 14, wherein the clustering the answer data to obtain the answer cluster comprises:
clustering the answer data based on a similarity between pairwise answer data to obtain an answer cluster, each answer cluster comprising at least one answer data.

16. The electronic device according to claim 15, wherein,
the target metric is a normalized Shannon entropy determined based on the probability, the probability being determined based on a quantity of answer data included in the answer cluster;
the determining the target question in the question data based on the target metric comprises:
determining question data having the target metric within a preset first threshold and a preset second threshold as the target question.

17. The electronic device according to claim 14, wherein the determining the target answer in the answer data corresponding to the target question comprises:
determining the target answer in the answer data corresponding to the target question based on the probability of the answer cluster corresponding to the target question.

18. The electronic device according to claim 17, wherein the determining the target answer in the answer data corresponding to the target question based on the probability of the answer cluster corresponding to the target question comprises:
selecting a preset number of answer clusters in a descending order of the probability of the answer cluster, and taking answer data within a selected answer cluster as the target answer.

19. The electronic device according to claim 13, wherein,
there are a plurality of target answers;
the performing self-correction on the target answer to obtain the error correction data comprises:
performing correction on the plurality of target answers based on a counterfactual correction algorithm to obtain multiple sets of correction trajectory data;
in response to answer data corresponding to the multiple sets of correction trajectory data being consistent, taking the multiple sets of correction trajectory data as the error correction data.

20. A non-transitory computer readable storage medium with computer instructions stored thereon, wherein the computer instructions are used for causing a method of large language model update, wherein the method of large language model update comprises:
performing autonomous data generation using an initial large language model to obtain synthetic data corresponding to multiple capabilities of the initial large language model;
constructing preference samples based on the synthetic data corresponding to the multiple capabilities;
training the initial large language model using the preference samples to obtain a target large language model.
